(19) United States
(12) Patent Application Publication
(10) Pub. No.: US 2011/0103194 A1
(43) Pub. Date: May 5, 2011

(54) Linear Clock

(76) Inventor: Scott Trantina, Sioux Falls, SD (US)

(21) Appl. No.: 12/916,479

(22) Filed: Oct. 29, 2010

Related U.S. Application Data
(60) Provisional application No. 61/257,022, filed on Nov. 1, 2009.

(51) Int. Cl. G04C 19/00; G04B 19/00

(52) U.S. Cl. 368/76; 368/82

(57) ABSTRACT

The Linear Clock is a clock comprising: a timer circuit for maintaining hours and minutes for the time of day, a segment member having an adjustable length, an hour display showing the hour of the day, and a control circuit. The control circuit is responsive to the timer circuit and coupled to the segment member and the hour display. The control circuit positions the starting point and stopping point of the segment member to adjust the length and position of the segment member thereby indicating the elapsed portion of an hour of the day maintained by the timer circuit. The control circuit also causes the hour display to show the hour of the day.

### CROSS REFERENCE TO RELATED APPLICATIONS

The application listed below is the only application related to this application. This application claims benefit of the earlier filing date under 35 USC 119(e) of provisional application No. 61/257,022 filed on Nov. 1, 2009.

### STATEMENT REGARDING FEDERALLY SPONSORED RESEARCH OR DEVELOPMENT

No invention claimed in this application was made under Federally sponsored research or development.

### THE NAMES OF THE PARTIES TO A JOINT RESEARCH AGREEMENT

Not Applicable

### REFERENCE TO A SEQUENCE LISTING

Not Applicable

### BACKGROUND OF THE INVENTION

1. Field of the Invention

This invention relates to a method and apparatus for displaying time, and, in particular, a clock display including a linear segment member indicating an elapsed portion of an hour operating in conjunction with an indication of the relevant hour.

2. Description of Related Art

Two major classes of clock are apparent in the existing art: Digital and Analogue. Analogue clocks typically display time of day by the familiar circular position of so-called hands. This is so familiar that the mere positioning of hands without any indicator markings on the background is sufficient to relate the time of day to the viewer. This is generally referred to as an analogue clock display. It will be appreciated that such a display can be implemented using digital display technology.

Digital clocks typically indicate the time of day by displaying the hour as a number, typically in the range 1 through 12, and the minute within the hour by a second number, typically in the range 0 to 59. This is the typical digital display.

Both digital and analogue methods for keeping track of time abound and are well known in the art. Further, the four possible combinations of digital or analogue time keeping and digital or analogue time display all have been tried with varying success.

The use of arc segments to indicate the time is one form of analogue display typified by U.S. Pat. No. 5,694,376 to Sullivan.

The coldness of the digital display doesn't convey a sense of urgency and the analogue display fails similarly because of it overwhelming familiarity.

The present invention relates to the use of a linear display format which overcomes these shortcomings.

### BRIEF SUMMARY OF THE INVENTION

The Linear Clock is a clock comprising: a timer circuit for maintaining hours and minutes for the time of day, a segment member having an adjustable length, an hour display showing the hour of the day, and a control circuit. The control circuit is responsive to the timer circuit and coupled to the segment member and the hour display. The control circuit positions the starting point and stopping point of the segment member to adjust the length and position of the segment member thereby indicating the elapsed portion of an hour of the day maintained by the timer circuit. The control circuit also causes the hour display to show the hour of the day.

It will be appreciated that the length of the segment member may be proportional to, inversely proportional to, or bear any relationship whatever to the elapsed portion of an hour, provided the relationship can be used to discern or indicate the elapsed fraction of an hour.

The segment member has a starting point indicating the start of an hour of the day and a stopping point terminating so that the adjustable length indicates a fraction of an hour of the day. The length of the segment member represents one hour when adjusted to a maximum length once during each hour of the day, and the fractional part of an hour is represented by the length of the segment member.

### BRIEF DESCRIPTION OF THE SEVERAL VIEWS OF THE DRAWING

FIG. 1 is a schematic view of the Linear Clock.

FIG. 2 is a first embodiment Linear Clock.

FIG. 3 is a second embodiment Linear Clock.

FIG. 4 is a third embodiment Linear Clock.

FIG. 5 is a schematic of an electronic embodiment of the Linear Clock.

FIG. 6 is a schematic of a mechanical embodiment of the Linear Clock

FIG. 7 is an alternative embodiment of the Linear Clock of FIG. 1.

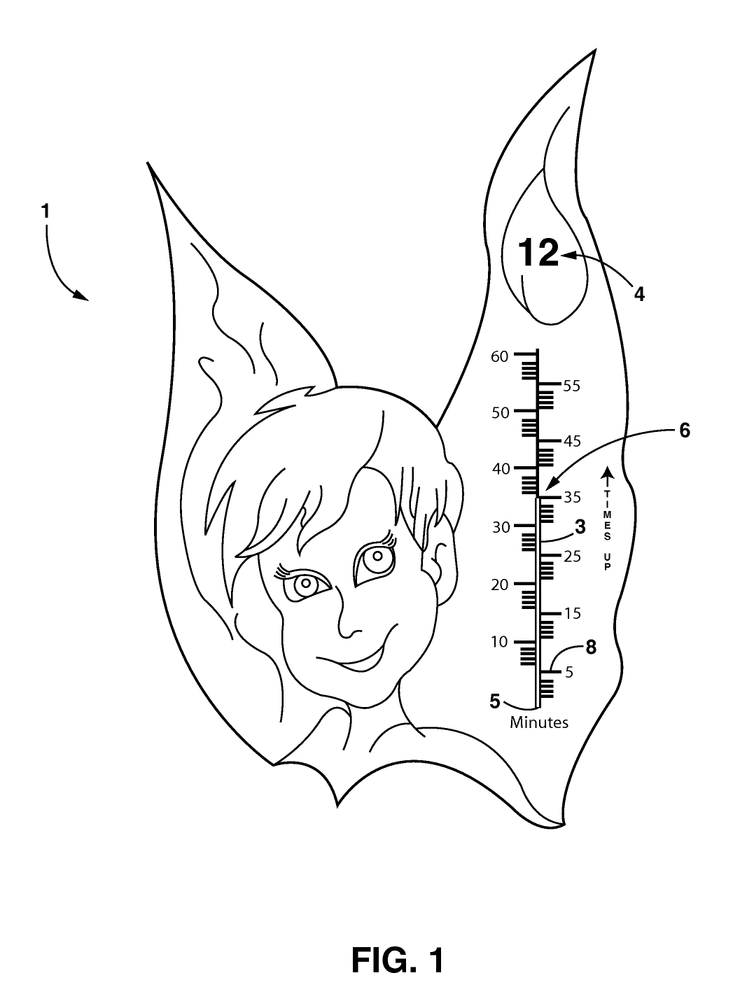

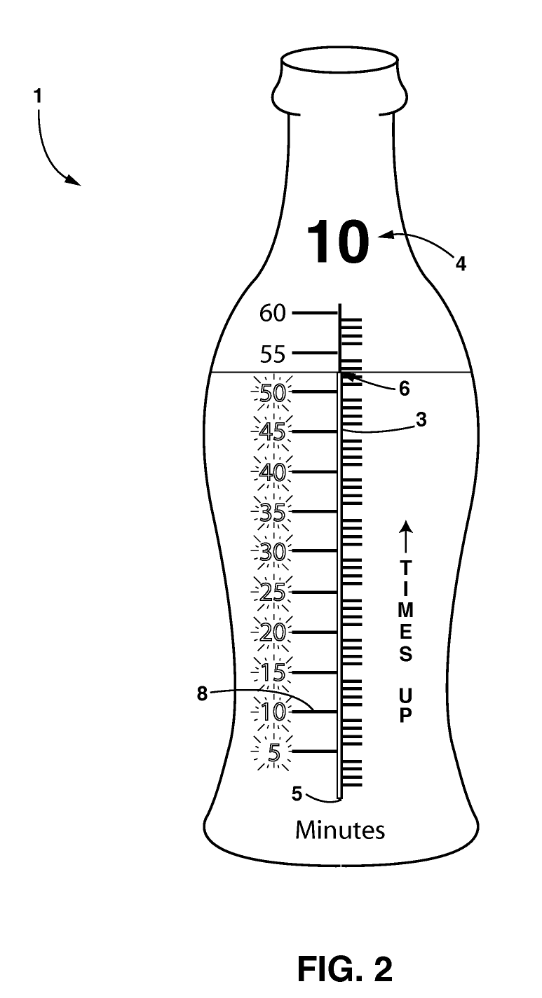

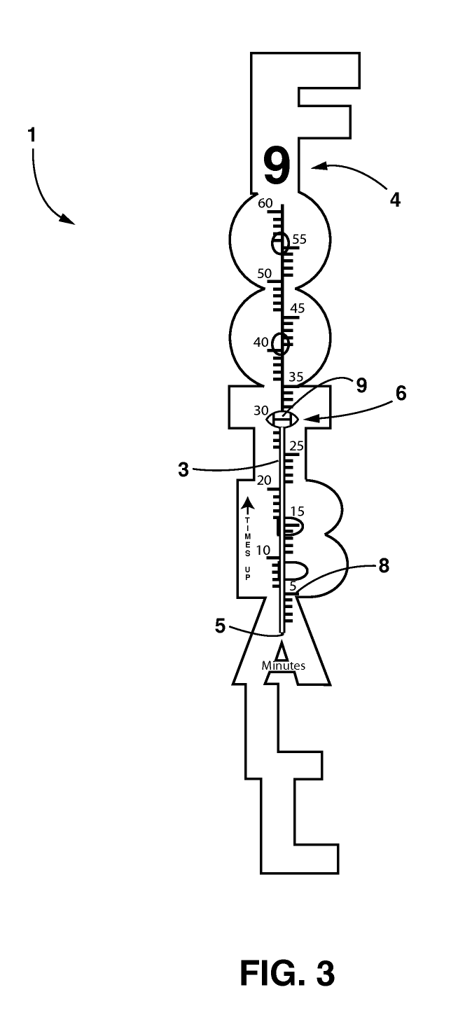

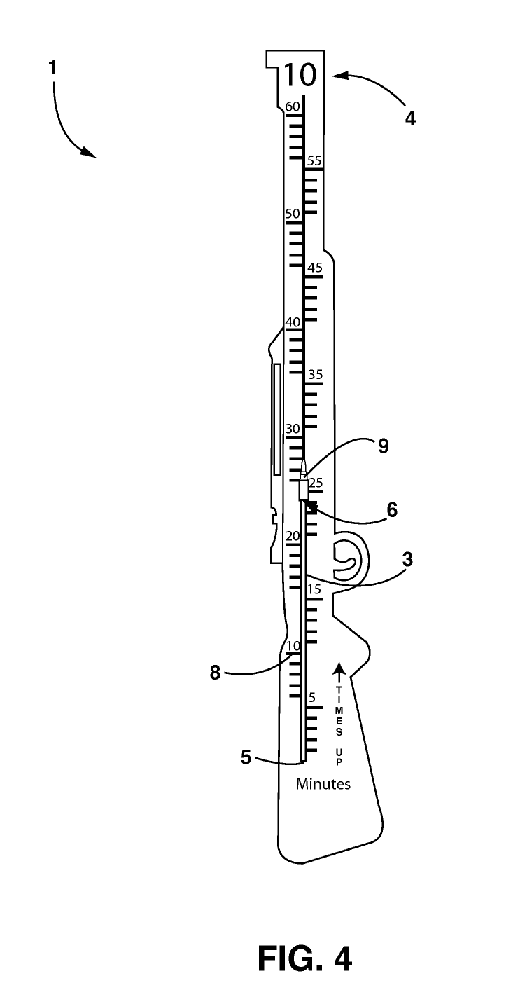

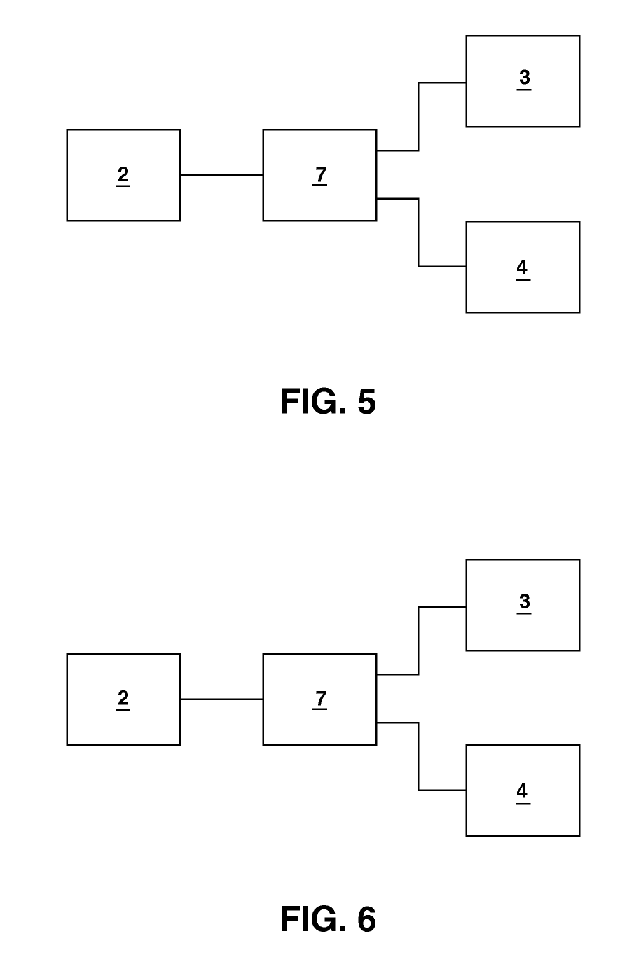

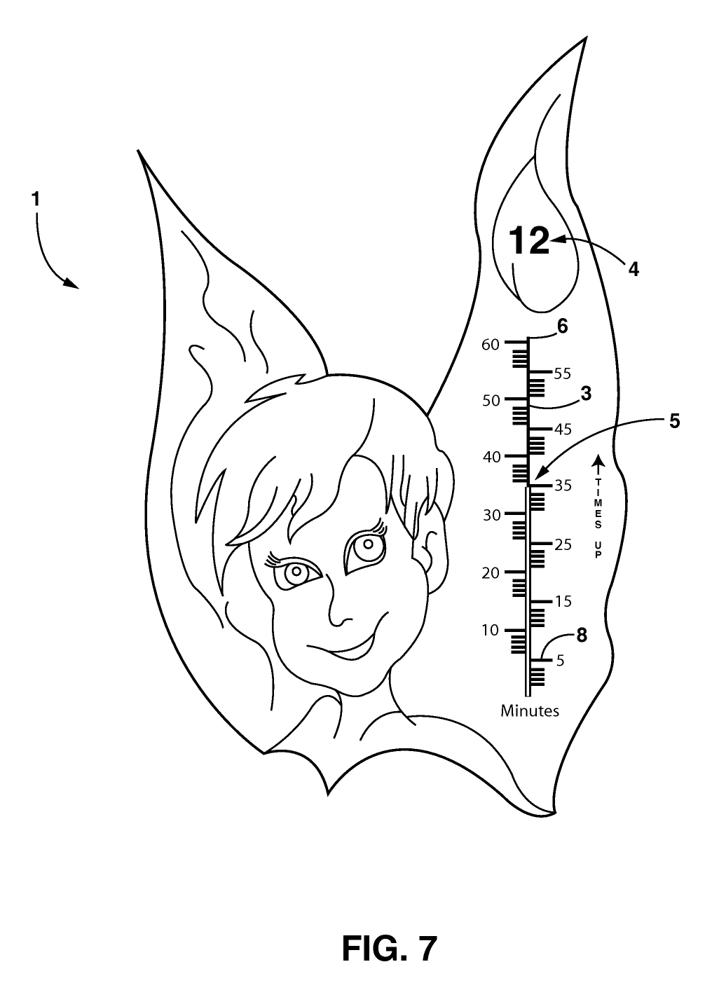

### DETAILED DESCRIPTION OF THE INVENTION

The Linear Clock 1 is a clock comprising: a timer circuit 2 for maintaining hours and minutes for the time of day, a segment member 3 having an adjustable length, an hour display 4 showing the hour of the day, and a control circuit 7, responsive to the timer circuit 2 and coupled to the segment member 3 and the hour display 4, for positioning the starting point 5 and stopping point 6 of the segment member 3 to adjust the length and position of the segment member 3 to indicate the elapsed portion of an hour of the day maintained by the timer circuit 2, and causing the hour display 4 to show the hour of the day. It will be appreciated that the length of the segment member 3 may be proportional to, inversely proportional to or bear any relationship to the elapsed portion of an hour, provided the relationship can be used to discern or indicate the elapsed fraction of an hour.

The segment member 3 has a starting point 5 indicating the start of an hour of the day and a stopping point 6 terminating so that the adjustable length indicates a fraction of an hour of the day. The length of the segment member 3 represents one hour when adjusted to a maximum length once during each hour of the day, and the fractional part of an hour is represented by the length of the segment member 3.

The timer circuit 2 may be of any design, electrical or mechanical, which keeps track of the time of day and provides electrical or mechanical outputs in any digital or analogue format suitable for interpretation by a compatible control circuit 7. An electrical oscillator and counter is an example of a digital electronic embodiment of the timer circuit 2. The oscillator and counter may be implemented using a microprocessor. A wind up spring controlled by an escapement mechanism is an example of a mechanical-analogue embodiment of the timer circuit 2. It will be appreciated that many combinations of electrical, mechanical, and electro-mechanical devices could be employed for this purpose and remain within the scope of the present invention.

The control circuit 7 may be of any design, electrical or mechanical, which interprets the signals from the timer circuit 2 and converts them to signals suitable for the segment member 3 and the hour display 4 to display the hour of the day maintained by the timer circuit 2. The control circuit 7 may be implemented using a translating read only memory or a rotating shaft and cam mechanism to position the segment member 3. The control circuit 7 may be implemented by a rotating shaft with an indicating arm (hour hand). It will be appreciated that many combinations of electrical, mechanical, and electro-mechanical devices could be employed for this purpose and remain within the scope of the present invention.

The segment member 3 is any mechanism which can indicate the fraction of an hour which has elapsed. An indicator 9 moving in a slot is a mechanical implementation of the segment member 3. A bar of lights which indicates a proportion of an hour by lighting an appropriate light or lights is an electronic implementation. It will be appreciated that many combinations of electrical, mechanical, and electro-mechanical devices could be employed for this purpose and remain within the scope of the present invention.

The Linear Clock 1 scale 8 is a set of markings positioned in proximity to the segment member 3 to aid in interpreting the hour of day indicated by the segment member 3.

The hour display 4 is any mechanism which indicates the hour of the day. This can be an hour hand or a digital readout. It will be appreciated that many combinations of electrical, mechanical, and electro-mechanical devices could be employed for this purpose and remain within the scope of the present invention.

The Linear Clock 1 may further comprise a scale 8 calibrated to show the portion of an hour indicated by the length of the illuminated segment member 3.

The Linear Clock 1 scale 8 may be calibrated in minutes.

The Linear Clock 1 scale 8 may be calibrated in fractions of an hour.

The Linear Clock 1 Scale 8 may be marked in minutes.

The Linear Clock 1 segment member 3 may be luminous.

I claim:

1) A clock comprising:
a) a timer circuit for maintaining hours and minutes for a time of day;
b) a segment member having an adjustable length defined between a starting point indicating the start of an hour of the day and a stopping point terminating so that the adjustable length indicates the minute of the hour of the day, the length of the segment member representing one hour when adjusted to a maximum length once during each hour of the day, and the fractional part of an hour is represented by the length of the segment;
c) an hour display showing the hour of the day; and
d) a control circuit, responsive to the timer circuit and coupled to the segment member and the display member, for: 1: positioning the starting and stopping points of the segment member to adjust the length and position of the segment member to indicate the elapsed portion of an hour day maintained by the timer circuit, and 2 causing the display to show the hour of the day.

2) The clock of claim 1 further comprising a scale calibrated to show the portion of an hour indicated by the segment member.

3) The clock of claim 2 wherein the scale calibration is in minutes.

4) The clock of claim 2 wherein the scale is in fractions of an hour.

5) The clock of claim 2 wherein the scale is marked in minutes.

6) The clock of claim 1 wherein the segment member is luminous.
